(19) United States
(12) Patent Application Publication
(10) Pub. No.: US 2012/0161640 A1
(43) Pub. Date: Jun. 28, 2012

(54) LED DRIVING APPARATUS

(75) Inventor: Kengo Kimura, Saitama-Ken (JP)

(73) Assignee: SANKEN ELECTRIC CO., LTD., Saitama (JP)

(21) Appl. No.: 13/328,975

(22) Filed: Dec. 16, 2011

(30) Foreign Application Priority Data
Dec. 27, 2010 (JP) 2010-290321

(51) Int. Cl. H05B 37/02

(52) U.S. Cl. 315/127

(57) ABSTRACT

An LED driving apparatus that converts input power into direct-current power and feeds the power to an LED unit, includes: a first transistor that turns current flowing to the LED unit between on-and-off; an LED current detector that detects the current flowing to the LED unit; a controller that outputs a control signal controlling power to be fed to the LED unit, based on an error between a detected voltage obtained by the LED current detector and a burst dimming signal to dim the LED unit; and a second transistor that controls the power to be fed to the LED unit, based on the control signal output from the controller, wherein the first transistor is turned on; based on the burst dimming signal, and wherein the first transistor is turned off, based on a delay signal that is delayed at a predetermined time from the burst dimming signal.

### CROSS-REFERENCE TO RELATED APPLICATION

This application claims priority from Japanese Patent Application No. 2010-290321 filed on Dec. 27, 2011, the entire subject matter of which is incorporated herein by reference.

### TECHNICAL FILED

This disclosure relates to an LED driving apparatus, and more specifically, to an LED driving apparatus that performs burst dimming.

### BACK GROUND

In recent years, in view of ecology and energy saving, a Light Emitting Diode (LED) lighting apparatus is attracted and is developed to take the place of an known lighting apparatus such as a bulb-type fluorescent lamp or straight type fluorescent lamp. The LED lighting apparatus has good characteristics such as a relatively longer life and lower power consumption. An LED lighting apparatus includes a power supply unit (LED driving apparatus), which converts input power into desired direct-current power and feeds the same to an LED-group load, and the LED-group load, in which a plurality of LEDs is connected in series. The power supply unit has a switching device, which feeds power to the LED-group load, and a switching device for dimming, which is connected to the LED-group load in series. In the LED driving apparatus of the related art, both the switching device for dimming, which is connected to the LED-group load, and the switching device, which feeds the power to the LED-group load, are on-and-off controlled in synchronization with a burst dimming signal input from the outside (for example, refer to JP-A-2004-147435).

Although the LED lighting apparatus has the above good characteristics, the replacement from the fluorescent lamp is not actively progressed. One of the reasons is a noise generated from the LED lighting apparatus. Due to the noise, a trouble may be caused in that a surrounding electric device does not work. In the LED lighting apparatus of the related art, a switching noise may be generated when turning on-and-off the switching device for dimming or a noise may be generated when current flowing in the LED-group load is turned on-and-off.

### SUMMARY

With considering the above, this disclosure provides an LED driving apparatus capable of reducing noises generated from an LED lighting apparatus.

An LED driving apparatus of this disclosure, which converts input power into direct-current power and feeds the power to an LED unit, the LED driving apparatus includes: a first transistor that turns current flowing to the LED unit between on-and-off; an LED current detector that detects the current flowing to the LED unit; a controller that outputs a control signal controlling power to be fed to the LED unit, based on an error between a detected voltage obtained by the LED current detector and a burst dimming signal to dim the LED unit; and a second transistor that controls the power to be fed to the LED unit, based on the control signal output from the controller, wherein the first transistor is turned on, based on the burst dimming signal, and wherein the first transistor is turned off, based on a delay signal that is delayed at a predetermined time from the burst dimming signal.

According to this disclosure, it is possible to provide the LED driving apparatus capable of reducing noises generated from the LED lighting apparatus.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 illustrates a circuit diagram showing an LED driving apparatus according to an illustrative embodiment of this disclosure;

FIG. 2 illustrates a circuit diagram of a control circuit of the LED driving apparatus according to an illustrative embodiment of this disclosure;

FIG. 3 illustrates a circuit diagram of a turn off delay circuit of the LED driving apparatus according to an illustrative embodiment of this disclosure;

FIG. 4 illustrates operation waveforms of the turn off delay circuit; and

FIG. 5 illustrates operation waveforms of the LED driving apparatus according to an illustrative embodiment of this disclosure.

### DETAILED DESCRIPTION

In the below, an illustrative embodiment of this disclosure will be described with reference to the drawings.

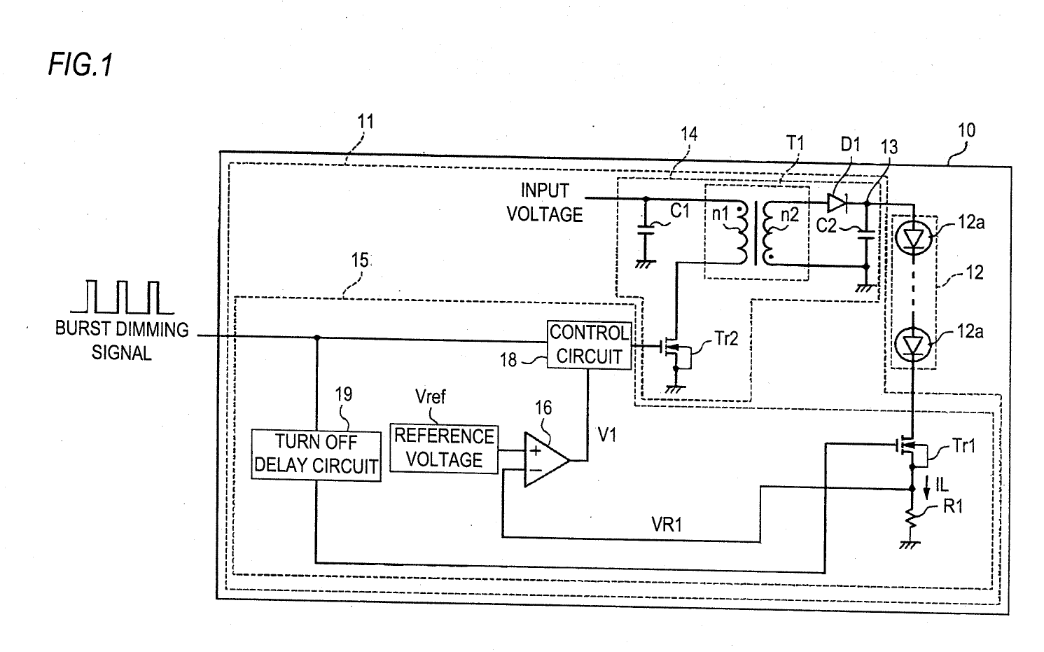

FIG. 1 illustrates a circuit diagram showing an LED driving apparatus according to an illustrative embodiment of this disclosure. An LED driving apparatus 11 converts input power into desired direct-current power and is connected to an LED unit 12 (LED-group load) having at least one LED 12a to feed the power to the LED unit 12. The LED driving apparatus 11 and the LED unit 12 configure an LED lighting apparatus 10.

The LED unit 12 is connected to the LED driving apparatus 11. The LED unit 12 may be configured by a plurality of LEDs 12a connected in series. In the meantime, the LED unit 12 may have one LED 12a. Also, it may be used that a light emitting load other than the LED 12a such that it emits light depending on flowing direct current.

The LED driving apparatus 11 has a power converter 14 and a controller 15.

The power converter 14 includes: a capacitor CI to smooth input voltage from a diode bridge that rectify an alternating-current voltage received at an input terminal (not shown); a series circuit having a primary winding n1 of a transformer T1 and a second transistor Tr2; a diode D1, whose anode is connected to one end of a secondary winding n2 of the transformer T1 and cathode is connected to an output terminal 13; and a capacitor C2 connected between the cathode of the diode D1 and the other end of the secondary winding n2 to smooth. As the second transistor Tr2 becomes on-and-off by a control signal from a control circuit 18, an output voltage (a voltage between both ends of the capacitor C2) corresponding to a pulse width of the control signal is applied to the LED unit 12.

In the meantime, a commercial alternating-current voltage and a rectifier circuit configured by the diode bridge may be replaced with a direct-current voltage source such as a battery. The power converter 14 may be configured to convert direct-current power fed from the direct-current power supply and to generate direct-current power for light emission of the LED unit 12. Also, the configuration having the transformer T1 is shown in the above power supply. However, this disclosure is not specifically limited to the presence or absence of the transformer and circuit configuration in the power converter 14.

The controller 15 includes a first transistor Tr1; a resistance R1 for LED current detection serving as an LED current detector; an error amplifier 16; the control circuit 18; and a turn off delay circuit 19.

The first transistor Tr1 is connected to the LED unit 12 in series and turns on-and-off the current flowing in the LED unit 12, based on a burst dimming signal input from the outside of the LED driving apparatus 11. The resistance R1 for LED current detection (hereinafter, abbreviated as the resistance R1) detects the current flowing in the LED unit 12. Since load current IL flowing in the LED unit 12 caused by the output voltage of the power converter 14 flows through the resistance R1 connected to the LED unit 12 in series, a voltage drop by the resistance R1, i.e., a detected voltage VR1, becomes a voltage corresponding to the load current IL. In the meantime, a current transformer may be used as the LED current detector.

The error amplifier 16 outputs a difference voltage V1 between the detected voltage VR1 by the resistance R1 and a reference voltage Vref to the control circuit 18. The burst dimming signal is a pulse signal having a frequency of 100 Hz to 1 kHz that is output from a dimmer(not shown) provided at the outside of the LED driving apparatus 11, for example. The control circuit 18 outputs a control signal to control the power to be fed to the LED unit 12, based on the difference voltage V1 from the error amplifier 16 and the burst dimming signal. The second transistor Tr2 controls the power to be fed to the LED unit 12, based on the control signal output from the control circuit 18. The turn off delay circuit 19 is connected to a control terminal of the first transistor Tr1 and delays the burst dimming signal to be input from the outside and outputs the same to the first transistor Tr1. The turn off delay circuit 19 turns on-and-off the first transistor Tr1, based on the burst dimming signal. When the burst dimming signal is an off instruction (when the signal is dropping), the turn off delay circuit 19 delays the burst dimming signal by a predetermined time so that the first transistor Tr1 becomes off later than a turn off timing of the second transistor Tr1 by the predetermined time. Also, when the burst dimming signal is an on instruction (when the signal is rising), the turn off delay circuit 19 outputs directly the burst dimming signal to the first transistor Tr1.

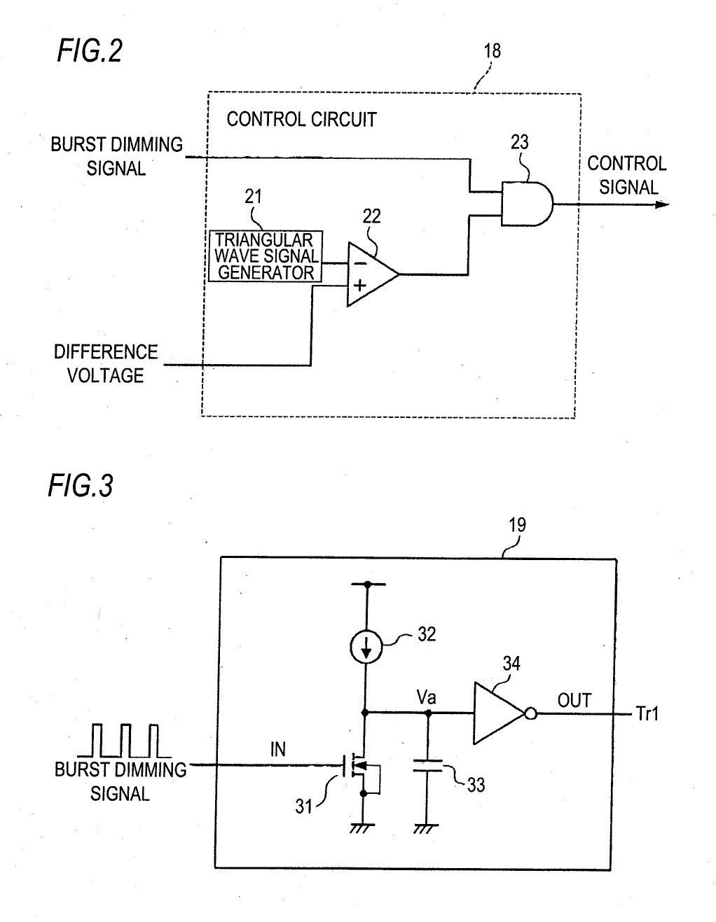

FIG. 2 illustrates a circuit diagram of the control circuit 18. The control circuit 18 has a PWM comparator 22 that generates a PWM signal, based on a triangular wave signal generated from a triangular wave signal generator 21 and the difference voltage V1, and an AND circuit 23 that calculates and outputs an AND operation between the burst dimming signal and the PWM signal output from the PWM comparator 22. The PWM signal generated from the PWM comparator 22 is a signal having a frequency of 50 kHz to 200 kHz, for example. The PWM comparator 22 outputs a pulse to the AND circuit 23. When the difference voltage V1, which is input to a non-inversion terminal from the error amplifier 16, is equal to or higher than a triangular wave, which is generated from the triangular wave generator 21 and input to an inversion terminal, the pulse becomes an H level. When the difference voltage V1 is lower than the triangular wave, the pulse becomes an L level. Then, the AND circuit 23 outputs a signal, which is a result of the AND operation between the input signal and the burst dimming signal, to the second transistor Tr2, as the control signal. When the burst dimming signal is an H level, the second transistor Tr2 is on-and-off controlled depending on the PWM signal output from the PWM comparator 22, and when the burst dimming signal is an L level, the second transistor becomes off. Thereby, the output voltage of the power converter 14 is regulated.

FIG. 3 illustrates a circuit diagram showing an example of the turn off delay circuit 19. The turn off delay circuit 19 includes a switching device 31, a constant current source 32, a capacitor 33 and a NOT circuit 34. The burst dimming signal input from the outside of the turn off delay circuit 19 is input to a gate terminal of the switching device 31. A drain terminal of the switching device 31 is connected to an output of the constant current source 32 and a source terminal thereof is grounded. One end of the capacitor 33 is connected to a connection point of the switching device 31 and the constant current source 32 and the other end thereof is grounded. An input terminal of the NOT circuit 34 is connected to the one end of the capacitor 33 and an output terminal thereof is connected to the gate terminal of the first transistor Tr1. The NOT circuit 34 is configured to output a signal of an L level when a voltage between both ends of the capacitor 33 is higher than a predetermined value.

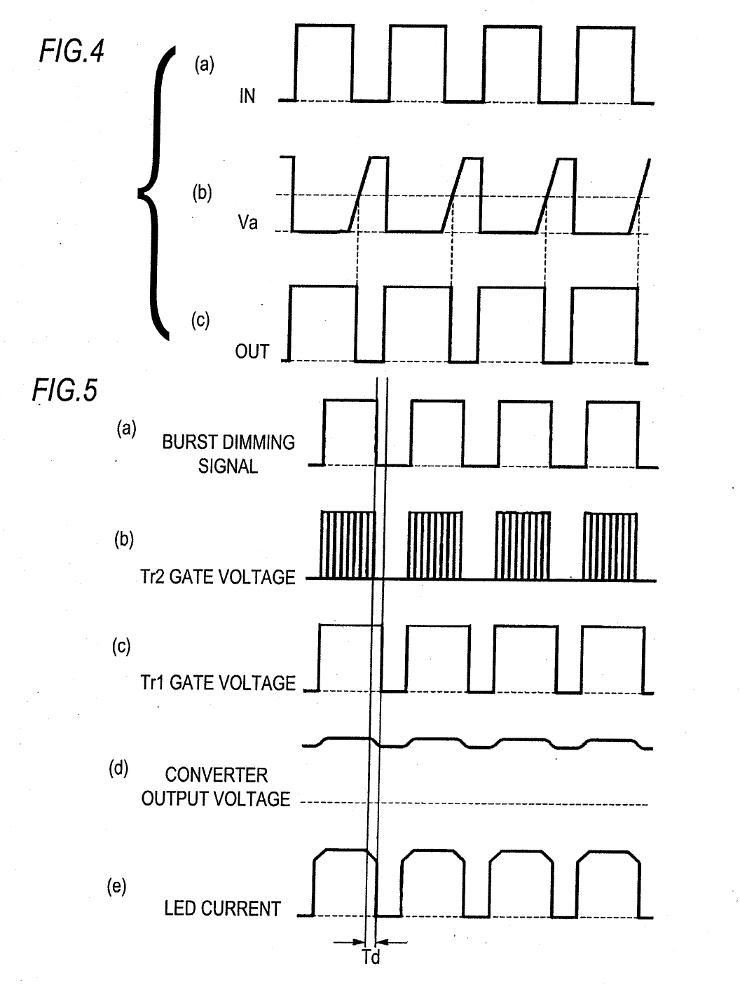

FIG. 4 illustrates operation waveforms of the turn off delay circuit 19. When a rectangular wave (burst dimming signal) of FIG. 4(a) is an L level, the switching device 31 becomes off and the capacitor 33 is charged by the constant current source 32. A voltage Va between both ends of the capacitor 33 is increased with a predetermined slope, as shown in FIG. 4(b). When the burst dimming signal is an H level, the switching device 31 becomes on and the capacitor 33 is instantaneously discharged. As shown in FIG. 4(c), the NOT circuit 34 outputs a signal OUT of an L level when the voltage between both ends of the capacitor 33 becomes higher than a predetermined value. Accordingly, the output of the turn off delay circuit 19 is dropped predetermined time later than the rising timing of the burst dimming signal.

In the below, operations of the LED driving apparatus 10 configured as described above are described with reference to FIGS. 1, 2 and 5. First, when the LED driving apparatus 11 starts to operate by a switch (not shown) of the LED driving apparatus 11, the load current IL flows to the LED unit 12 and the resistance R1, so that the detected voltage VR1 is supplied to the controller 15. The error amplifier 16 outputs the difference voltage V1 between the detected voltage VR1 and the reference voltage Vref to the control circuit 18. The PWM comparator 22 of the control circuit 18 forms a PWM signal, based on the difference voltage V1 output from the error amplifier 16 and the triangular wave generated from the triangular wave generator 21, and outputs the same to the AND circuit 23. Then, the AND circuit outputs a signal, which is a result of the AND operation between the PWM signal and the burst dimming signal, to the second transistor Tr2. During a period in which the burst dimming signal is an H level, the second transistor Tr2 performs a switching operation in accordance with the PWM signal. Accordingly, the output voltage is controlled so that the load current IL has a desired magnitude. Also, at this time, the burst dimming signal is also input to the first transistor Tr1 via the turn off delay circuit 19 and the current is thus made to be intermittent, so that the light emission of the LED unit 12 can be regulated.

At this time, when the burst dimming signal of FIG. 5(a) is input, a gate voltage of the second transistor Tr2, which is a signal obtained by the AND operation between the PWM signal output from the PWM comparator 22 and the burst dimming signal, is output from the AND circuit 23, as shown in FIG. 5(b). Also, since the burst dimming signal, whose the turn off is delayed at a predetermined time Td by the turn off delay circuit 19, is input, a gate voltage of the first transistor Tr1 is turned off with delayed at the predetermined time Td, as shown in FIG. 5(c). Thereby, the electrical charges charged in the capacitor C2 are discharged through the LED unit 12 during the predetermined time Td that is the delay time. Accordingly, compared to a configuration in which the turn off delay circuit 19 is not provided, the output voltage of the LED driving apparatus 11 is decreased at a moment at which the first transistor Tr1 becomes off. Also, just after the first transistor Tr1 is turned on, the capacitor C2 is charged and the voltage between the capacitor C2 is maintained so that the desired current flows in the LED unit 12. Therefore, the output voltage becomes as shown in FIG. 5(d). Specifically, a rising part thereof has a gradient, the output voltage softly rises without instantaneous and sharp increase at the time of rising, and the output voltage softly drops without instantaneous and sharp decrease at the time of discharge. The predetermined time Td is determined by a time constant of the constant current source 32 and the capacitor 33. The predetermined timed Td is preferably set as time so that, after the second transistor Tr2 is turned off and the electrical charges charged in the capacitor C2 of the LED driving apparatus 11 are discharged through the LED unit 12, and the output voltage is kept higher than a voltage at which the light of the LED unit 12 is turned off. Thereby, as shown in FIG. 5(e), the LED current is softly operated by a soft on operation, in which there is no instantaneous and sharp rising current such as inrush current, and a soft off operation, in which there is no instantaneous and sharp dropping current.

Thereby, since the sharp change of the current flowing in the LED unit 12 is suppressed, the noise to be generated from the LED unit 12 and the switching noise of the first transistor Tr1 are reduced. Also, since the inrush current flowing in the LED unit 12 is reduced, it is possible to provide an LED driving apparatus that does not apply excessive stress to the LED.

The configuration, shape, size and arrangement relation described in the illustrative embodiment are only schematically shown to understand and implement this disclosure. Accordingly, this disclosure is not limited to the described illustrative embodiment and can be variously changed without departing from this disclosure.

The LED driving apparatus of this disclosure is used as a driving apparatus of dimmable LED lighting.

What is claimed is:

1. An LED driving apparatus that converts input power into direct-current power and feeds the power to an LED unit, the LED driving apparatus comprising:
a first transistor that turns current flowing to the LED unit between on-and-off;
an LED current detector that detects the current flowing to the LED unit;
a controller that outputs a control signal controlling power to be fed to the LED unit, based on an error between a detected voltage obtained by the LED current detector and a burst dimming signal to dim the LED unit; and
a second transistor that controls the power to be fed to the LED unit, based on the control signal output from the controller,
wherein the first transistor is turned on, based on the burst dimming signal, and
wherein the first transistor is turned off, based on a delay signal that is delayed at a predetermined time from the burst dimming signal.

2. The LED driving apparatus according to claim 1,
wherein the controller comprises a turn off delay circuit that turns off the first transistor so that the first transistor is turned off later than a turn off timing of the second transistor at the predetermined time, when the burst dimming signal instructs to off.

3. The LED driving apparatus according to claim 1,
wherein the controller includes:
a PWM comparator that generates a PWM signal based on a triangular wave signal generated from a triangular wave signal generator and a differential voltage; and
an AND circuit that calculates an AND operation between the burst dimming signal and the signal output from the PWM comparator and output a result of the AND operation.

4. The LED driving apparatus according to claim I,
wherein the predetermined time is set so that an output voltage of the capacitor is kept higher than a voltage at which light of the LED unit is turned off, after the second transistor is turned off and an electrical charge charged in a capacitor connected to the LED unit are discharged through the LED unit.
